(19) United States
(12) Patent Application Publication
(10) Pub. No.: US 2010/0272190 A1
(43) Pub. Date: Oct. 28, 2010

(54) SCALABLE TRANSMITTING/RECEIVING APPARATUS AND METHOD FOR IMPROVING AVAILABILITY OF BROADCASTING SERVICE

(75) Inventors: Seungchul Kim, Daejon (KR); Pansoo Kim, Daejon (KR); Dae-Ig Chang, Daejon (KR)

Correspondence Address: LAHIVE & COCKFIELD, LLP;FLOOR 30, SUITE 3000, ONE POST OFFICE SQUARE, BOSTON, MA, 02109, US

(73) Assignee: ELECTRONICS AND TELECOMMUNICATIONS RESEARCH INSTITUTE, DAEJON (KR)

(21) Appl. No.: 12/809,472

(22) PCT Filed: Sep. 4, 2008
(86) PCT No.: PCT/KR08/05219

§ 371 Date: Jun. 18, 2010

(30) Foreign Application Priority Data
Dec. 19, 2007 (KR) 10-2007-0133824

(51) Int. Cl. H04N 7/26

(52) U.S. Cl. 375/240.26; 375/240.01; 375/E07.078

(57) ABSTRACT

Provided is a scalable transmitting/receiving apparatus and method for improving availability of a broadcasting service, which can allow a reception party to select an optimum video according to an attenuation degree of a broadcasting signal by scalably encoding video data and transmitting it by a different transmission scheme for each layer. The scalable transmitting apparatus for improving availability of a broadcasting service includes: a scalable video encoder for scalably encoding video data to generate scalable video elementary streams having logical layers; a multiplexer for multiplexing the multiple scalable video elementary stream, a compressed audio elementary stream, and program specification information to generate a transport stream; and a scalable transmitter for separating the transport stream into multiple TS packet streams according to pre-given priority information, and transmitting the packet streams by a different transmission scheme for each layer. down-sampler

### TECHNICAL FIELD

The present invention relates to a scalable transmitting/receiving apparatus and method for improving availability of a broadcasting service; and, more particularly, to a scalable transmitting/receiving apparatus and method for improving availability of a broadcasting service, which can allow a reception party to select an optimum video according to an attenuation degree of a broadcasting signal by scalably encoding video data and transmitting it by a different transmission scheme for each layer.

This work was supported by the IT R&D program of MIC/IITA [2007-S-008-01, “Development of 21 GHz Band Satellite Broadcasting Transmission Technology”].

### BACKGROUND ART

In the field of satellite broadcasting services, various coding techniques and transmission techniques are being developed to provide a high-definition (HD) video service. Thus, the quality of the satellite broadcasting service is being improved.

However, since the satellite broadcasting service is sensitive to weather conditions such as rainfalls, the service may be interrupted for a certain period of time due to the adverse weather condition.

Particularly, a high data rate and a good wireless channel environment are required to provide the HD video service. However, it is almost impossible to always meet such transmission conditions because of characteristics of the wireless channel environment of the satellite broadcasting.

Therefore, there is a need to scalably encode media data, particularly, video data, based on a resolution and average image quality, and to transmit the encoded data by a different transmission scheme including e.g., an encoding rate and a modulation scheme for each layer in due consideration of a characteristic of each encoding layer such as a base layer and an enhancement layer.

### DISCLOSURE OF INVENTION

### Technical Problem

An embodiment of the present invention is directed to providing a scalable transmitting/receiving apparatus and method for improving availability of a broadcasting service, which can prevent service interruption from occurring due to the adverse weather conditions such as rainfalls.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a scalable transmitting/receiving apparatus and method for improving availability of a broadcasting service, which can scalably encode video data and transmit the encoded data by a different transmission scheme including e.g., an encoding rate and a modulation scheme for each layer.

In accordance with an aspect of the present invention, there is provided a scalable transmitting apparatus for improving availability of a broadcasting service, the apparatus which includes: a scalable video encoder for scalably encoding video data to generate scalable a scalable video elementary stream which has logical layers; a multiplexer for multiplexing the scalable video elementary stream, a compressed audio elementary stream and program specification information to generate a transport stream; and a scalable transmitter for separating the single TS packet stream into multiple TS streams according to pre-given priority information, and transmitting the packet streams by a different transmission scheme for each layer.

In accordance with another aspect of the present invention, there is provided a scalable receiving apparatus for improving availability of a broadcasting service, the apparatus which includes: a scalable receiver for restoring packet streams by each layer from a broadcasting reception signal and combining the restored packet streams to restore a single transport stream; a demultiplexer for demultiplexing the transport stream to split the transport stream into scalable video elementary stream, an audio elementary stream and program specification information; and a video decoder for decoding the multiple scalable video elementary streams.

In accordance with another aspect of the present invention, there is provided a scalable transmitting method for improving availability of a broadcasting service, the method which includes: scalable video encoding to generate a scalable video elementary stream; multiplexing the generated scalable video elementary stream, a compressed audio elementary stream and program specification information to generate a single transport stream; and separating the single TS packet stream into multiple layers according to pre-given priority information to transmit the packets by a different transmission method for each layer.

### Advantageous Effects

The present invention can provide a satellite broadcasting service adaptively to transmission channel characteristics, performance of a receiving terminal, and subscription conditions of a subscriber by dividing an uncompressed video image into several layers based on a frame rate, image quality or resolution. And then the input images are encoded using scalable video coding technology. Scalably coded video elementary stream has logical layers. An upper layer includes side information additionally needed to increase the frame rate, image quality or resolution for a decoding result of a lower layer.

Also, the present invention can prevent loss of all digital video streams in a transmission environment where errors may occur by separating the digital video stream encoded in stages into those of each layer, and transmitting them through different transmission schemes.

Thus, even when signal distortion/attenuation occurs during a transmission process because of conditions such as weather, quality degradation may be caused due to decoding by a Scalable Video Coding (SVC) scheme but the probability that service outage occurs is decreased.

That is, in accordance with the embodiments of the present invention, optimum reception quality can be achieved according to weather and reception conditions of each zone. A high definition (HD) image can be received under the normal weather conditions such as normal rainfalls, and a standard definition (SD) image can be received under the adverse weather conditions such as heavy rainfalls or rainstorms.

Particularly, multi-channel high-quality satellite broadcasting can be provided even when satellite service is provided using a Ka frequency band, which has abundant frequency resources but is vulnerable to rainfall attenuation.

### BRIEF DESCRIPTION OF THE DRAWINGS

FIG. 1 is a block diagram of a scalable transmitting/receiving apparatus for improving availability of a satellite broadcasting service, in accordance with an embodiment of the present invention.

FIG. 2 illustrates a transport stream generated at a multiplexer illustrated in FIG. 1, in accordance with an embodiment of the present invention.

FIG. 3 is a block diagram of a scalable separator illustrated in FIG. 1, in accordance with an embodiment of the present invention.

FIG. 4 is a view for explaining specification information of a program map table (PMT) applied to the present invention.

FIGS. 5 and 6 are views for explaining a transmitting method using a variable modulation scheme of a Digital Video Broadcasting (DVB)-S2 modulator/transmitter illustrated in FIG. 1, in accordance with an embodiment of the present invention.

### MODE FOR THE INVENTION

In accordance with embodiments of the present invention, video data is transmitted by using an H.264 Scalable Video Coding (SVC) scheme and a DVB-S2 Variable Coding and Modulation (VCM) scheme, so that a reception party can select a video of quality that is suitable for a characteristic change of a transmission channel and can view the selected video.

That is, in accordance with the embodiments of the present invention, in the case of a Ka band HD satellite broadcasting, a scalable video stream that is scalably separated into a standard definition (SD) video and a HD video is transmitted by the DVB-S2 VCM scheme. Accordingly, the reception party can view the SD or HD video according to attenuation and distortion degrees of a broadcasting signal transmitted to the reception party.

The advantages, features and aspects of the invention will become apparent from the following description of the embodiments with reference to the accompanying drawings, which is set forth hereinafter. These embodiments are provided so that this disclosure will be thorough and complete, and will fully convey the scope of the present invention to those skilled in the art.

In some embodiments, well-known processes, device structures, and technologies will not be described in detail to avoid ambiguousness of the present invention. Preferred embodiments of the present invention will be described below in more detail with reference to the accompanying drawings.

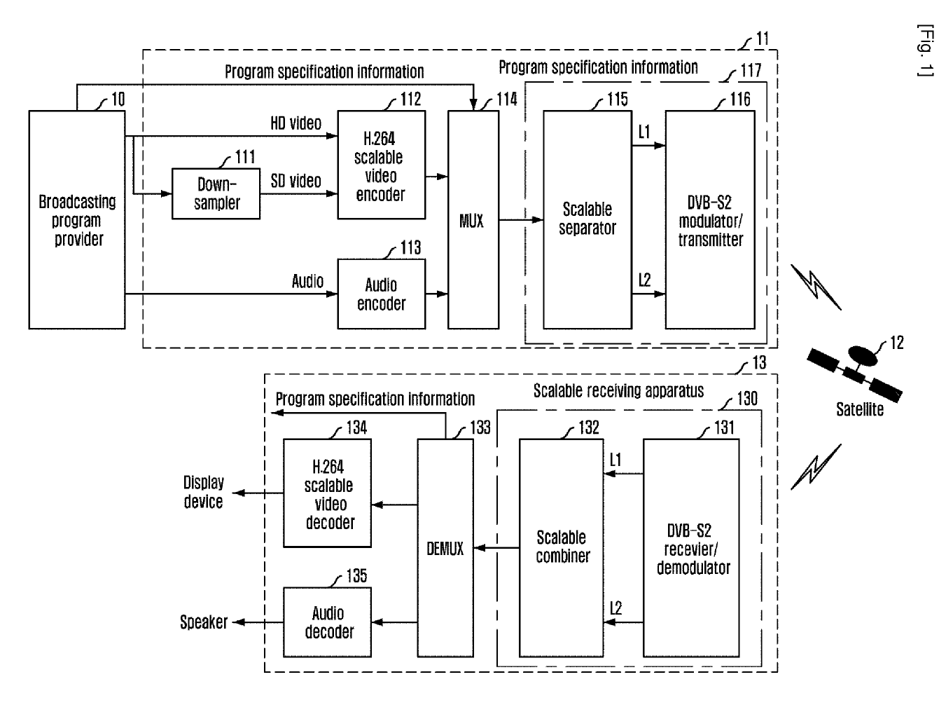

FIG. 1 is a block diagram of a scalable transmitting/receiving apparatus for improving availability of a satellite broadcasting service, in accordance with an embodiment of the present invention.

First, a scalable transmitting apparatus 11 in accordance with the embodiment of the present invention will be described. As shown in FIG. 1, the scalable transmitting apparatus 11 includes a down-sampler 111, an H.264 scalable video encoder 112, an audio encoder 113, a multiplexer 114 (hereinafter, referred to as a MUX), a scalable separator 115 and a DVB-S2 modulator and transmitter 116 (hereinafter referred to as a DVB-S2 modulator/transmitter). The scalable separator 115 and the DVB-S2 modulator/transmitter 116 may be collectively called a scalable transmission unit 117. Hereinafter, each element will be described.

The down-sampler 111 converts an HD video, i.e., HD resolution video data provided from a broadcasting program provider 10 into SD resolution video data.

The H.264 scalable video encoder 112 generates a spatial scalable video compression stream with respect to the HD resolution video data provided from the broadcasting program provider 10 and the SD resolution video data input from the down-sampler 111.

That is, the H.264 scalable video encoder 112 receives the HD resolution video data provided from the broadcasting program provider 10 and down-samples the HD data to generate the SD resolution video data, and then generates a spatial scalable video stream having two layers, i.e., a base-layer video stream and an enhancement-layer video stream. In another embodiment, one base-layer video stream and multiple enhancement-layer video streams may be generated.

The two layers are a base layer and an enhancement layer. The base layer corresponds to a compression result of an SD resolution image compatible to the H.264 Advanced Video Coding (AVC) standard, and the enhancement layer corresponds to a result of compression and encoding performed by referencing an input HD resolution image and an encoding result of the base layer according to the H.264 SVC standard. If only a base-layer video stream is decoded, an SD image may be restored, and if an enhancement-layer video stream is decoded together with the base-layer video stream, an HD image may be restored. The enhancement-layer video stream cannot be decoded alone.

The down-sampler 111 and the H.264 scalable video encoder 112 may be collectively called a ‘video encoder’ because they scalably encode video data provided from the broadcasting program provider 10 and generate multiple scalable video streams.

The audio encoder 113 generates a compressed and encoded audio stream with respect to audio data input from the broadcasting program provider 10.

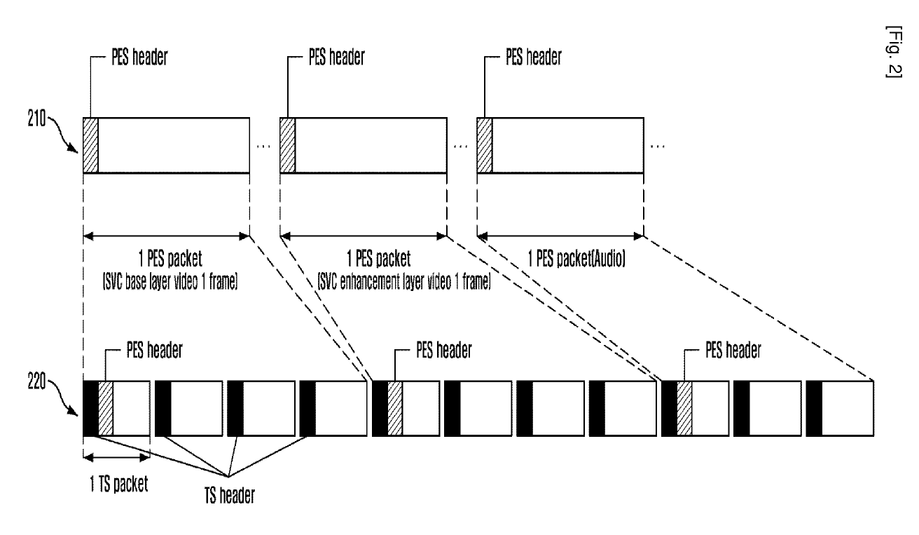

The MUX 114 packetizes and multiplexes the compressed and encoded video and audio streams of the H.264 scalable video encoder 112 and the audio encoder 113, and program specification information, i.e., a stream map, thereby generating Moving Picture Experts Group (MPEG)-2 transport stream (TS) packets. Detailed description thereof will be made later with reference to FIG. 2.

The scalable transmission unit 117 separates the MPEG-2 TS packets into multiple layers and transmits them by using a different transmission scheme for each layer. The scalable transmission unit 117 includes the scalable separator 115 and the DVB-S2 modulator/transmitter 116.

The scalable separator 115 separates the TS packets generated by the MUX 114 into a first layer (L1) packet stream and a second layer (L2) packet stream. The first layer (L1) packet stream includes a base-layer video packet, an audio packet and a program specification information packet. The second layer (L2) packet stream includes an enhancement-layer video packet.

The DVB-S2 modulator/transmitter 116 applies different error correction encoding rates and modulation schemes to the first layer (L1) packet stream and the second layer (L2) packet stream, and transmits them to the satellite 12. In detail, as for the first layer (L1) packet stream that is the most important, the DVB-S2 modulator/transmitter 116 performs encoding such that the first layer (L1) packet stream has smaller data quantity than that of the second layer (L2) packet stream, and applies to the first layer (L1) packet stream, a channel encoding algorithm with a high error correction ability, and a Quadrature Phase Shift Keying (QPSK) modulation scheme allowing relatively stable reception.

To sum up, the scalable transmitting apparatus 11 generates scalable broadcasting packet data using the H.264 SVC scheme, and scalably transmits it using the DVB-S2 VCM scheme.

A scalable receiving apparatus 13 will now be described.

As shown in FIG. 1, the scalable transmitting apparatus 13 includes a DVB-S2 receiver and demodulator 131 (hereinafter, referred to as a DVB-S2 receiver/demodulator), a scalable combiner 132, a demultiplexer 133 (hereinafter, referred to as a Demux), an H.264 scalable video decoder 134 and an audio decoder 135. The DVB-S2 receiver/demodulator 131 and the scalable combiner 132 may be collectively called a ‘scalable reception unit’ 130.

The scalable reception unit 130 restores packet streams for each layer from a satellite reception signal, and combines them to generate, i.e., restore one transport stream (TS). The scalable reception unit 130 includes the DVB-S2 receiver/demodulator 131 and the scalable combiner 132.

The DVB-S2 receiver/demodulator 131 receives/demodulates a satellite broadcasting signal from the satellite 12, and restores a first layer (L1) packet steam and a second layer (L2) packet stream.

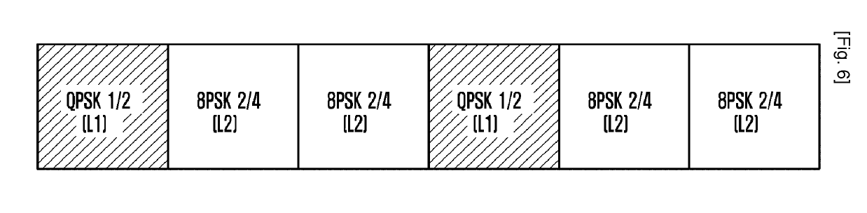

In detail, the DVB-S2 receiver/demodulator 131 interprets an encoding rate and modulation information specified in a header of a transmission frame received via the satellite 12, and decodes the rest of the frame by using the interpretation result. The DVB-S2 receiver/demodulator 131 outputs a decoding result of a QPSK ½ transmission frame to a port corresponding to the first layer (L1), and outputs a decoding result of a QPSK 8/9 or 8PSK ⅔ transmission frame to a port corresponding to the second layer (L2) (see FIGS. 5 and 6).

The scalable combiner 132 combines the restored first layer (L1) packet stream and second layer (L2) packet stream in the input order, thereby generating, i.e., restoring a single TS.

The DEMUX 133 demultiplexes and depacketizes the TS, and splits it into an H.264 scalable video stream such as a base-layer video steam and an enhancement-layer video stream, an audio stream and program specification information. Based on information specified in a packetized elementary stream (PES) header or a header of each TS packet, the DEMUX 133 performs audio-video synchronization, and splits the video into a base-layer video stream and an enhancement-layer video stream and outputs them.

Base-layer video packets and enhancement-layer video packets for the same image have the same time information value in respective PES headers. The DEMUX 133 examines the video stream packets, i.e., the base-layer video stream packet and the enhancement-layer video packet, for errors and loss, so that an invalid PES packet is discarded, and only a valid PES packet is converted into a video stream. Then, the DEMUX 133 transmits the converted video stream to the H264 scalable video decoder 134.

The H.264 scalable video decoder 134 decodes the restored H.264 scalable video stream into video data. If both a base-layer video stream and an enhancement-layer video stream are transmitted, the H.264 scalable video decoder 134 decodes each of the video streams and combines them to generate an HD video. If only a base-layer video stream is transmitted, the H.264 scalable video decoder 134 decodes the video steam to generate an SD video.

The audio decoder 135 decodes an audio stream into audio data.

FIG. 2 illustrates a transport stream generated at the MUX 114 of FIG. 1, in accordance with an embodiment of the present invention.

The MUX 114 of FIG. 1 packetizes and multiplexes program specification information, i.e., a stream map, a compressed and encoded SVC video stream, i.e., a base-layer video stream and an enhancement-layer video stream, and an audio stream, thereby generating an MPEG-2 TS. Different program identifications (PIDs) are allocated to a video stream corresponding to a base layer, a video stream corresponding to an enhancement layer, and an audio stream.

The MUX 114 packetizes the base-layer video stream, the enhancement video stream and the audio stream output from the encoders 112 and 113 into respective PES packets 210. Thereafter, the MUX 114 packetizes the PES packets 210 into TS packets 220. One PES packet is packetized into one or more TS packets.

That is, as shown in FIG. 2, the TS generated at the MUX 114 includes an audio TS packet, a base-layer video TS packet and an enhancement-layer video TS packet each having different PIDs. The program specification information is included in a header of the TS packet.

Through the reverse operation of the operation illustrated in FIG. 2, the DEMUX 133 splits the transport stream (TS) into the H.264 scalable video stream, e.g., the base-layer video stream and the enhancement-layer video stream, the audio stream and the program specification information.

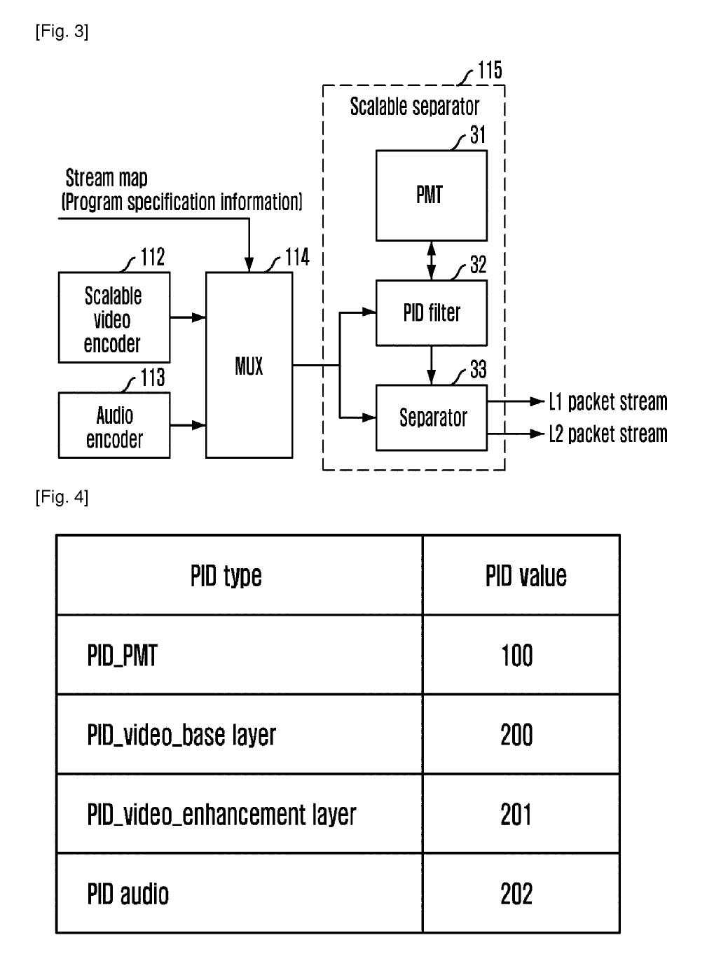

FIG. 3 is a block diagram of the scalable separator 115 of FIG. 1, in accordance with an embodiment of the present invention.

Through a PID filter 32, the scalable separator 115 finds packets including program specification information (PSI) and stores PID information allocated to a base-layer video packet, an enhancement-layer video packet and an audio packet of the program specification information in a Program Map Table (PMT) 31.

The PID filter 32 compares a PID of a packet input from the MUX 114 with PID information stored in the PMT 31 to confirm a packet type, and controls a separator 33 according to the confirmation result.

Then, the separator 33 outputs a program specification information packet, an audio packet and a base-layer video packet as the first layer (L1) and outputs an enhancement-layer video packet as the second layer (L2) under the control of the PID filter 32. The separator 33 is a kind of a demultiplexer.

If the present invention is expanded for application to multi-channel broadcasting, the PMT stores therein specification information of every program, and the PID filter 32 provides control regardless of a program type such that every packet corresponding to the program specification information/base-layer video/audio packet is output as the first layer (L1) and every packet corresponding to the enhancement-layer video is output to the second layer (L2).

The first layer (L1) and second layer (L2) packet streams that are scalably separated by the scalable separator 115 are input to the DVB-S2 modulator/transmitter 116.

Then, the DVB-S2 modulator/transmitter 116 applies a different modulation scheme and encoding rate for each layer to each packet stream. The average data rate of the first layer (L1) packet stream including the SD resolution video and audio is lower than that of the second layer (L2) packet stream including an HD resolution video, and thus frame transmission is performed in the order as illustrated in FIGS. 5 and 6.

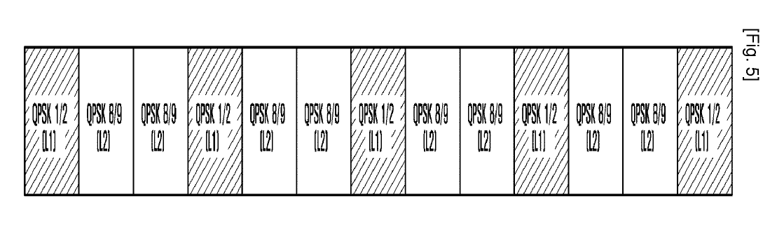

FIG. 4 is a view for explaining specification information of a PMT applied to the present invention.

As shown in FIG. 4, a PID type includes PIDs respectively representing a PMT packet, a base-layer video packet, an enhancement-layer video packet (PID-PMT, PID_video_base layer, PID_video_enhancement layer and PID_audio). Respective PID values thereof are ‘100’, ‘200’, ‘201’ and ‘202’.

The PID filter 32 of the scalable separator 115 checks a PID value of a packet input from the MUX 114 to recognize a type of the corresponding packet, and separates the packet by layer according to the recognition result. For example, if the PID value of a packet is ‘200’, the packet is recognized as a base-layer video packet and is classified as the first layer (L1).

FIGS. 5 and 6 are views for explaining a transmitting method using a VCM scheme of the DVB-S2 modulator/transmitter 116 of FIG. 1, in accordance with an embodiment of the present invention.

The DVB-S2 modulator/transmitter 116 performs error-correction encoding of an encoding rate of ½ and QPSK modulation on a first layer (L1) packet stream, and transmit. According to the general video compression result statistics, a compression bit rate of an HD image is average three to four times greater than a compression bit rate of an SD video image. Thus, the DVB-S2 modulator/transmitter 116 performs error-correction encoding on a second layer (L2) packet stream at an encoding rate of ⅔ or 8/9. In the case of the error-correction encoding of the encoding rate of ⅔, the 8PSK modulation is performed on the stream, and in the case of the encoding rate of 8/9, the QPSK modulation is performed thereon.

FIG. 5 illustrates a structure of a TS structure when the error-correction encoding of the encoding rate of 8/9 and the QPSK modulation scheme are applied with respect to the second layer (L2). FIG. 6 illustrates a TS structure when the error-correction encoding of the encoding rate of ⅔ and the 8PSK modulation scheme are applied with respect to the second layer (L2).

Referring to FIG. 5, one QPSK ½ frame of the first layer (L1) is transmitted, and then two QPSK 8/9 frames of the second layer (L2) are transmitted. Referring to FIG. 6, one QPSK ½ frame of the first layer (L1) is transmitted and then two 8PSK ⅔ frames of the second layer (L2) are transmitted. A detailed process associated with frame configuration, encoding and modulation for transmission is based on the DVB-S2 standard, and information of the encoding rate and modulation scheme is transmitted to the scalable receiving apparatus 13, together with the first layer (L1)/second layer (L2) packet data.

The DVB-S2 receiver/demodulator 131 interprets the encoding rate and modulation information specified in a header of a transmission frame received via the satellite 12, and decodes the rest of the frame by using the interpretation result. The DVB-S2 receiver/demodulator 131 outputs a decoding result of a QPSK ½ transmission frame to a port corresponding to the first layer (L1), and outputs a decoding result of a QPSK 8/9 or 8PSK ⅔ transmission frame to a port corresponding to the second layer (L2).

The method of the present invention described above may be programmed for a computer. Codes and code segments constituting the computer program may be easily inferred by a computer programmer of ordinary skill in the art to which the present invention pertains. The computer program may be stored in a computer-readable recording medium, i.e., data storage, and it may be read and executed by a computer to realize the method of the present invention. The recording medium includes all types of computer-readable recording media.

The present application contains subject matter related to Korean Patent Application No. 2007-0133824, filed in the Korean Intellectual Property Office on Dec. 19, 2007, the entire contents of which is incorporated herein by reference.

While the present invention has been described with respect to the specific embodiments, it will be apparent to those skilled in the art that various changes and modifications may be made without departing from the spirit and scope of the invention as defined in the following claims.

1. A scalable transmitting apparatus for improving availability of a broadcasting service, the apparatus comprising:
a scalable video encoder for scalably encoding video data to generate scalable video elementary stream which has logical layers;
a multiplexer for multiplexing the scalable video elementary stream, a compressed audio elementary stream, and program specification information to generate a transport stream (TS); and
a scalable transmitter for separating the TS into multiple TSs according to pre-given priority information, and transmitting the packet streams by a different transmission scheme for each layer.

2. The scalable transmitting apparatus of claim 1, wherein the video encoder generates a base-layer video stream and an enhancement-layer video stream according to spatial Scalable Video Coding (SVC).

3. The scalable transmitting apparatus of claim 2, wherein the scalable transmitter classifies the program specification information and the base-layer video stream as a first layer packet stream to transmit, and classifies the enhancement-layer video stream as a second layer packet stream to transmit.

4. The scalable transmitting apparatus of claim 3, wherein the scalable transmitter applies a lower encoding rate to the first layer packet stream than to the second layer packet stream.

5. The scalable transmitting apparatus of claim 4, wherein the scalable transmitter applies a Quadrature Phase Shift Keying (QPSK) modulation scheme to the first layer packet stream, and applies a Phase Shift Keying (PSK) modulation scheme to the second layer packet stream.

6. The scalable transmitting apparatus of claim 1, wherein the scalable transmitter separates the transport stream into the multiple layers by using program identifications (PIDs) respectively allocated to the packets of the transport stream.

7. A scalable receiving apparatus for improving availability of a broadcasting service, the apparatus comprising:
a scalable receiver for restoring packet streams by each layer from a broadcasting reception signal and combining the restored packet streams to restore a transport stream;
a demultiplexer for demultiplexing the transport stream to split the transport stream into scalable video elementary stream, an audio elementary stream, and program specification information; and
a video decoder for decoding the multiple scalable video streams.

8. The scalable receiving apparatus of claim 7, wherein the scalable receiver de-modulates the broadcasting reception signal to restore a first layer packet stream including a base-layer video stream and program specification information, and a second layer packet stream including an enhancement-layer video stream, and then combines the first layer packet stream and the second layer packet stream in the input order to restore the transport stream.

9. The scalable receiving apparatus of claim 8, wherein the demultiplexer splits the transport stream into the base-layer video stream, the program specification information and the enhancement-layer video stream.

10. The scalable receiving apparatus of claim 9, wherein the demultiplexer checks a packet error on the enhancement-layer video stream, and discards an errored packet.

11. A scalable transmitting method for improving availability of a broadcasting service, the method comprising:
scalably encoding video data to generate scalable video elementary stream;
multiplexing the generated scalable video elementary stream, a compressed audio elementary stream, and program specification information to generate a transport stream; and
separating the transport stream into multiple layers according to pre-given priority information to transmit the packets by a different transmission method for each layer.

12. The scalable transmitting method of claim 11, wherein said encoding of the video data generates a base-layer video elementary stream and an enhancement-layer video elementary stream according to spatial Scalable Video Coding (SVC).

13. The scalable transmitting method of claim 12, wherein said separating of the packets comprises:
classifying the program specification information and the base-layer video stream as a first layer packet stream, and the enhancement video stream as a second packet stream; and
transmitting the first layer packet stream and the second layer packet stream on the same transmission band by different transmission schemes.

14. The scalable transmitting method of claim 13, wherein said transmitting of the first layer packet stream and the second layer packet stream comprising applying a lower encoding rate to the first layer packet stream than to the second layer packet stream.

15. The scalable transmitting method of claim 13, wherein said transmitting of the first layer packet stream and the second layer packet stream comprising applying a Quadrature Phase Shift Keying (QPSK) modulation scheme to the first layer packet stream, and a Phase Shift Keying (PSK) modulation scheme to the second layer packet stream.
